(19) United States
(12) Patent Application Publication
(10) Pub. No.: US 2006/0209395 A1
(43) Pub. Date: Sep. 21, 2006

(54) Semiconductor laser and method for manufacturing the same

(75) Inventor: Chiaki Sasaoka, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 10/549,447

(22) PCT Filed: Feb. 26, 2004
(86) PCT No.: PCT/JP04/02281

§ 371 Date: Sep. 14, 2005

(30) Foreign Application Priority Data
Mar. 26, 2003 (JP) 2003085132

(51) Int. Cl. H01S 3/00

(52) U.S. Cl. 359/344

(57) ABSTRACT

Damages in the semiconductor layers at the chip separating surfaces are suppressed in a semiconductor laser employing a GaN-based semiconductor substrate made of GaN and AlGaN. Laminated layers including a n-type clad layer (502) made of AlGaN and a multi-quantum well (MQW) layer (504) serving to be an active layer is formed on an independent GaN substrate (501). The side surfaces of the laminated layers along the direction of the resonator are inclined in such a direction that the resonator width is decreased from the independent GaN substrate (501) to the laminated layers.

### TECHNICAL FIELD

The present invention relates to semiconductor lasers employing a GaN-based semiconductor substrate and the methods of fabricating the same.

### BACKGROUND ART

GaN-based semiconductors as typified by gallium nitride have attracted attentions as materials of light emitting diodes (LEDs) and laser diodes (LDs), since they enable emission of blue-violet light with high efficiencies. In particular, LDs is expected to be used as the light sources of large-capacity optical disk apparatuses and, in recent years, the development of high-output LDs as light sources for writing has been strenuously advanced.

Conventionally, devices employing GaN-based semiconductors have been fabricated using substrates made of heterogeneous materials such as sapphire or SiC or the like. Namely, wurtzite GaN (0001) layers have been grown on a sapphire substrate or a SiC substrate with a two-step depositing method and these GaN layers have been used as the substrate to fabricate device structures. This is because it has been impossible to provide high-quality bulk GaN single-crystal substrates.

However, in the case of using such a substrate of different type, dislocations have been introduced into the GaN layers with high densities due to the lattice-constant difference between the substrate and the GaN, thus making it difficult to provide high-quality crystals. Furthermore, the use of a sapphire substrate causes various practical problems such as the low heat conductivity which causes poor heat-discharge characteristics of the devices, the difference of cleavage planes between GaN and sapphire which makes it difficult to fabricate mirrors during the LD fabrication, and impossibility of fabricating back-surface-electrode type devices since it is insulator.

Under the aforementioned circumstances, in recent years, there have been studied techniques for combining GaN thick-film depositing techniques employing HVPE (hydride Vapor phase Epitaxy) and dislocation reducing techniques employing selective growth to provide high-quality GaN substrates including reduced dislocations. By employing GaN substrates having excellent heat conductivity characteristics and electrical conductivity characteristics, it is possible to expect improvement of heat-discharge characteristics and the realization of back-surface-electrode type semiconductor lasers and the like. Consequently, devices formed on a GaN substrate will possibly become mainstream, in the future.

In order to employ a method of fabricating semiconductor devices using such a GaN substrate, there is a need for overcoming many issues in terms of processes. As one of the issues, it is an important technical issue as to which method should be employed for dividing the substrate and semiconductor layers into chips after depositing the semiconductor layers on the substrate. A GaN substrate having a wurtzite structure does not include cleavage planes along two directions orthogonal to each other on the wafer surface and, therefore, it is impossible to provide rectangular-shaped chips only by cleaving. On the other hand, a GaN substrate is significantly hard and therefore if an attempt is made to cut it along a plane which is not along the direction of cleavage, this will tend to cause clacks. Consequently, there will be arisen the problem of the occurrence of clacks during chip separation.

Japanese Patent Application Laid-Open (JP-A) No. 2001-176823 discloses a technique for suppressing the occurrence of clacks. JP-A No. 2001-176823 discloses a technique which forms splitting slots in the device formation surface, forms splitting slots with a smaller width than that of the aforementioned splitting slots in the back surface of the substrate and separates the devices using these slots. The columns 0041 to 0042 and FIG. 1 in JP-A No. 2001-176823 describe the chip separation process for a light emitting diode. Hereinafter, this process will be described with reference to FIG. 9. This light emitting diode is constituted by a C-plane (0001) n-type GaN substrate 100, a n-type GaN buffer layer 101, a n-type AlGaN clad layer 102, an active layer 103, a p-type AlGaN clad layer 104, a p-type GaN contact layer 105, a n-type electrode 106, a p-type electrode 107, an A-th splitting slot 108 and a B-th splitting slot 109. After the formation of the A-th splitting slot 108 by dry etching, the B-th splitting slot 109 is formed using a scriber. After the scribing, the vacuum chuck is released, the wafer is disengaged from the table and the n-type electrode 106 is formed over the entire surface of the GaN substrate side of the wafer. Subsequently, a cohesive sheet is attached to the crystal-growth side surface (the p-type electrode formation surface) and then it is lightly pressed by a roller from the GaN-substrate side to provide a number of chips having a dimension of 350 μm×250 μm from the 2-inch φ wafer. It has been said that this method can provide devices which include no clack, chipping or the like generated on the chip cut surfaces and also include no contour defect.

### DISCLOSURE OF THE INVENTION

There are mainly described examples of applications to light emitting diodes in the section of embodiments in JP-A No. 2001-176823 including the aforementioned description. On the other hand, in the case of forming semiconductor lasers using a GaN-based semiconductor substrate, if clacks are generated within the device structure, then the portions will become scattering centers, thus increasing the internal loss and degrading the device characteristics. Consequently, in fabricating semiconductor lasers, it is necessary to pay more attention to the prevention of damages in the semiconductor layers during the chip separation process, than in processes for fabricating other devices such as electronic devices or light emitting diodes or the like.

In addition, detailed experiments conducted by the inventors revealed that the utilization of a GaN substrate induces a greater number of clacks generated within the AlGaN layer during device separation than the case of utilizing a substrate made of sapphire or SiC.

The mechanism of generation of clacks during device separation can be considered as follows. For a gallium-nitride-based semiconductor laser, InₓAl_{y}Ga_{1-x-y}N mixed crystals containing GaN, In and Al are laminated and used to be an active layer. For an LD, a n-type GaN contact layer, a n-type AlGaN light confinement layer, a n-type GaN light guide layer, an InGaN multi quantum well active layer, a p-type GaN light guide layer, a p-type AlGaN light confinement layer, and a p-type GaN contact layer are successively laminated. AlN has a lattice constant smaller than that of GaN and also AlGaN which is a mixed crystal has a lattice constant smaller than that of GaN. Consequently, tensile-mode internal stresses will remain within the AlGaN layer laminated on the GaN substrate.

Such internal stresses remaining within layers make the LD structure susceptible to defects such as clacks, thus causing degradation of the reliability of the devices. Particularly, during the device separation process for extracting respective devices from the wafer, the semiconductor layers are locally subjected to large stresses and therefore they are prone to clacks. Clacks are generated within layers being subjected to tensile stresses, and therefore it is deemed that devices on a GaN substrate including greater internal stresses within the AlGaN layer are more susceptible to occurrence of clacks than devices on a sapphire substrate or SiC substrate.

In view of the aforementioned facts, it is an important technical issue to address damages of semiconductor layers during chip separation, in the chip separation process for semiconductor lasers using a GaN-based semiconductor substrate in particular. For overcoming the technical issue, there is a need for design ideas from viewpoints other than chip separation for light emitting diodes. Particularly, it is desirable to provide a chip structure less prone to damages even after the separation as well as during chip separating operations. For example, conventional semiconductor lasers are sometimes damaged at the corner portions of the chip uppermost layers. Such chips may occur during the chip separation process in some cases or may occur when tools for holding chips are butted against the corner portions of the chip uppermost layers during transfer of separated chips in other cases.

The present invention was made in view of the aforementioned circumstances and it is an object of the present invention to suppress damages of semiconductor layers at their chip separated surfaces, in semiconductor lasers employing a GaN-based semiconductor substrate made of GaN or AlGaN or the like. Further, it is another object of the present invention to prevent clacks from reaching the active layer to improve the reliability of semiconductor lasers, even when clacks have been generated on the chip separated surfaces during chip separation processes or the like.

According to the present invention, there is provided a semiconductor laser including a GaN-based semiconductor substrate and laminated layers formed on the GaN-based semiconductor substrate which include a GaN-based semiconductor clad layer containing Al and an active layer formed thereabove, wherein the side surfaces of the aforementioned laminated layers along the direction of the resonator of the semiconductor laser are inclined in such a direction that the resonator width is decreased from the aforementioned GaN-based semiconductor substrate to the upper portion of the aforementioned laminated layers.

The side surfaces of the aforementioned laminated layers become separating surfaces for separating the laser devices from the wafer. The semiconductor laser according to the present invention is configured such that these separating surfaces are inclined. This can suppress damages of the semiconductor layers at the cut portions, particularly detects at the corner portions of the uppermost layer out of the semiconductor layers. FIG. 11 is a view explaining this. A semiconductor laser having a conventional structure including separating surfaces perpendicular to the substrate surface is prone to detects at the corner portions of the uppermost layer out of the semiconductor layers as illustrated in FIG. 11A. On the contrary, with the structure according to the present invention, the corner portions of the uppermost layer out of the semiconductor layers are formed an angle greater than a right angle as illustrated in FIG. 11(b), thus effectively suppressing the occurrence of such detects. In the present specification, “the direction of resonator” refers to the direction in which the resonator extends and refers to the direction parallel to the direction of light emission. “The resonator width” refers to the lateral width of the laser device along a plane surface perpendicular to “the direction of resonator”.

In the semiconductor laser according to the present invention, masks are formed on the GaN-based semiconductor substrate and the laminated layers are formed above the masks so that the side surfaces of the laminated layers along the direction of resonator may be formed from the grown surfaces of the semiconductor layers which have been selectively grown from the masks.

With this structure, the grown surfaces of the semiconductor layers which have been selectively grown from the mask opening portions become the separating surfaces of the laser device without being modified. This can effectively suppress the occurrence of clacks involved in the cutting of the wafer.

Further, according to the present invention, there is provided a semiconductor laser including a GaN-based semiconductor substrate and laminated layers formed on the GaN-based semiconductor substrate which include a GaN-based semiconductor clad layer containing Al and an active layer formed thereabove, wherein there are formed a pair of slots extending in the direction of the resonator of this semiconductor laser and the active layer is formed in the region sandwiched between the pair of slots.

According to the present invention, the pair of slots can prevent the propagation of clacks to maintain the laminated-layer structure including the active layer at high quality, even when clacks have been generated on the separating surfaces and propagated in the horizontal direction of the substrate.

In the semiconductor laser, masks may be provided on the bottom surfaces of the pair of slots so that the side surfaces of the slots are formed from the grown surfaces of the semiconductor layers which have been selectively grown from the masks. This enables forming the slots without applying processes such as dry etching, thus significantly reducing damages of semiconductor layers around the slots.

In the semiconductor laser according to the present invention, the pair of slots may include exposed surfaces of the GaN-based semiconductor clad layer containing Al and the side surfaces of the slots may be inclined in such a direction that the width between the slots is decreased from the GaN-based semiconductor substrate side to the upper portion of the laminated layers. By forming slots having such a shape, it is possible to decrease distortions within the semiconductor layers around the slots, thus further improving the reliability of the device.

In the structure of the semiconductor laser according to the present invention, the end surfaces of the resonator of this semiconductor laser are may be cleavage planes of the GaN-based semiconductor substrate and the aforementioned laminated layers. This structure can effectively suppress the occurrence of clacks on the entire side surfaces of the semiconductor laser. Since the resonator end surface forming the light emitting surface is a cleavage plane, it is possible to significantly suppress the occurrence of clacks. On the other hand, for the side surfaces perpendicular to the resonator end surfaces, namely the side surfaces along the direction of the resonator of the semiconductor laser, the side surfaces may be inclined or a pair of slots may be provided to suppress the occurrence of damages.

Further, according to the present invention, there is provided a semiconductor laser fabricating method including the steps of forming laminated layers having a GaN-based semiconductor clad layer containing Al and an active layer formed thereabove, on a wafer made of a GaN-based semiconductor, forming plural slots extending in the direction of the resonator of the semiconductor laser through the laminated layers by selectively removing the laminated layers, cutting the wafer along the direction orthogonal to the direction in which the slots extend to form bars, and cutting the bars in parallel with the direction in which the slots extend to separate them into semiconductor laser chips, wherein the slots include exposed surfaces of the GaN-based semiconductor clad layer containing Al and the side surfaces of the slots are inclined in such a direction that the width between the slots is decreased from the GaN-based semiconductor substrate side to the upper portion of the laminated layers.

With the fabricating method, it is possible to suppress the occurrence of clacks during separating the devices from the wafer, thus providing semiconductor lasers with excellent reliability.

Further, according to the present invention, there is provided a semiconductor laser fabricating method including the steps of forming a plurality of stripe-shaped masks extending in a single direction on a wafer made of a GaN-based semiconductor, selectively growing laminated layers including a GaN-based semiconductor clad layer and an active layer formed thereabove from the opening portions of the aforementioned masks while forming slots just above the masks, cutting the wafer along the direction orthogonal to the direction in which the aforementioned slots extend to form bars, and cutting the bars in parallel with the direction in which the slots extend to separate them into semiconductor laser chips.

With the aforementioned fabricating method, it is possible to suppress the occurrence of clacks during separating the devices from the wafer. Further, it is possible to form slots without applying processes such as dry etching, and to reduce damages on the semiconductor layers around the slots.

In the aforementioned fabricating method, the bars may be cut at the slots or other regions than the slots. When the bars are cut at regions other than the slots, it is preferable that they are separated into semiconductor laser chips including a pair of slots.

Further, according to the present invention, there is provided a semiconductor laser fabricating method including the steps of forming laminated layers including a GaN-based semiconductor clad layer containing Al and an active layer formed thereabove, on a wafer made of a GaN-based semiconductor, forming plural slots extending in the direction of the resonator of the semiconductor laser through the laminated layers by selectively removing the laminated layers, cutting the wafer along the direction orthogonal to the direction in which the slots extend to form bars, and cutting the aforementioned bars in parallel with the direction in which the slots extend, at regions other than the slots to separate them into semiconductor laser chips including a pair of slots.

This fabricating method includes the step of forming separating slots for preventing the propagation of clacks and therefore enables provision of semiconductor lasers with high reliability. The pair of slots may include exposed surfaces of the GaN-based semiconductor clad layer containing Al and the side surfaces of the slots may be inclined in such a direction that the width between the slots is decreased from the GaN-based semiconductor substrate side to the upper portion of the laminated layers.

In the semiconductor laser fabricating method according to the present invention, the bar forming step may be performed by cleaving. This can significantly suppress the occurrence of clacks.

In the present invention, “the GaN-based semiconductor” includes GaN and AlGaN and preferably uses GaN. In the case of a structure containing Al, it has to have an aluminum composition lower than that of the clad layer.

The present invention forms clack propagation preventing slots in which all or a part of the GaN-based semiconductor clad layer containing Al has been eliminated by selective deposition or etching to suppress the occurrence of clacks during scribing or dicing.

A first essence of the present invention is that a part or all of the GaN-based semiconductor clad layer containing Al which is formed on the GaN-based semiconductor substrate is eliminated to form device separating slots and the device is separated at the aforementioned slots by scribing or dicing. As previously described, clacks are generated when the GaN-based semiconductor clad layer containing Al which includes internal tensile stresses is subjected to local mechanical stresses. By separating the device at the regions where the GaN-based semiconductor clad layer containing Al has been eliminated, it is possible to suppress the occurrence of clacks.

A second essence of the present invention is that there are formed, around the device region, clack propagation preventing slots in which a part or all of the GaN-based semiconductor clad layer containing Al which is formed on the GaN-based semiconductor substrate has been eliminated and the device is separated at regions outside of the clack propagation preventing slot by scribing or dicing. Even if clacks are generated, this will not degrade the device characteristics as long as such clacks are not propagated to the active layer region. In some cases, clacks generated during device separation may reach several centimeters by propagation and the force which induces such propagation is caused by internal stresses existing within the GaN-based semiconductor clad layer containing Al. Consequently, by providing regions which are no GaN-based semiconductor layer containing Al therein, it is possible to prevent clacks from propagating any more once the clacks reach the regions. Furthermore, as a second effect of the clack propagation preventing slots, it is possible to reduce parasitic capacitances. In the case of a LD as a light source for optical disks, generally, high-frequency modulation is applied thereto for reducing noise during operation. In order to improve the response characteristics at high frequencies, it is important to reduce the device resistance and the parasitic capacitance. In order to reduce the parasitic capacitance, it is most effective to reduce the effective device area. In the case of a nitride-based LD, a typical device size is a length of about 600 μm and a width of about 300 μm, which becomes the effective device area. On the other hand, in the case where clack propagation preventing slots are provided near the active layer stripe of an LD, the electrically-effective width is the distance between the clack preventing slots sandwiching the active layer and therefore the electrically-effective width may be made about 10 μm. This enables significantly reduce the parasitic capacitance.

As described above, the present invention can effectively suppress damages of the semiconductor layers at the chip separating surfaces.

### BRIEF DESCRIPTION OF THE DRAWINGS

The aforementioned and other objects, features and advantages will be more apparent from the following description of preferable embodiments and the following drawings accompanying therewith.

FIG. 1 is a cross sectional view of a semiconductor laser according to an example.

FIG. 2 is a cross sectional view of a semiconductor laser according to an example.

FIG. 3 is a cross sectional view of a semiconductor laser according to an example.

FIG. 4A and FIG. 4B are cross sectional views of processes for a semiconductor laser according to an example.

FIG. 5A and FIG. 5B are cross sectional views of processes for a semiconductor laser according to an example.

FIG. 6A and FIG. 6B are cross sectional views of processes for a semiconductor laser according to an example.

FIG. 7A and FIG. 7B are cross sectional views of processes for a semiconductor laser according to an example.

FIG. 8 is a cross sectional view of processes for a semiconductor laser according to an example.

FIG. 9 is a cross sectional view of processes for a conventional semiconductor laser according to an example.

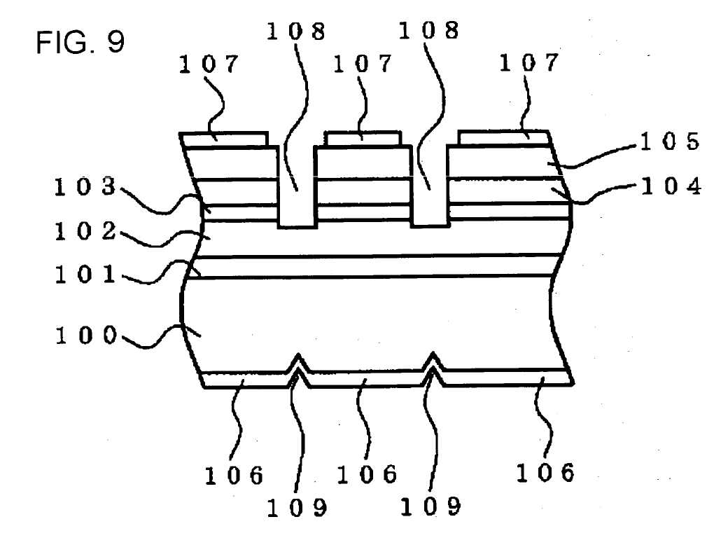

FIG. 10 is a cross sectional view of processes for a semiconductor laser according to an example.

FIG. 11A and FIG. 11B are views for explaining the state of damages generated during chip separation for a semiconductor laser.

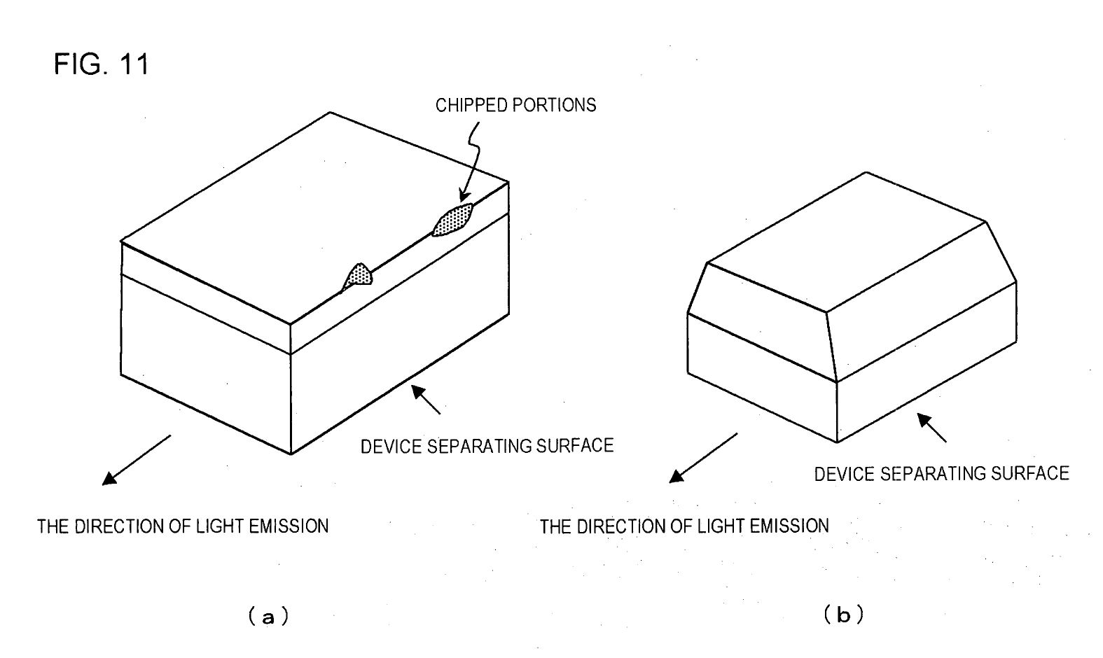

### BEST MODE FOR CARRYING OUT THE INVENTION

Hereinafter, there will be described preferred embodiments of the present invention. In these semiconductor lasers, the emitting surfaces of the semiconductor lasers are constituted by cleavage planes, namely (1-100) planes, of a GaN substrate and GaN-based semiconductor layers.

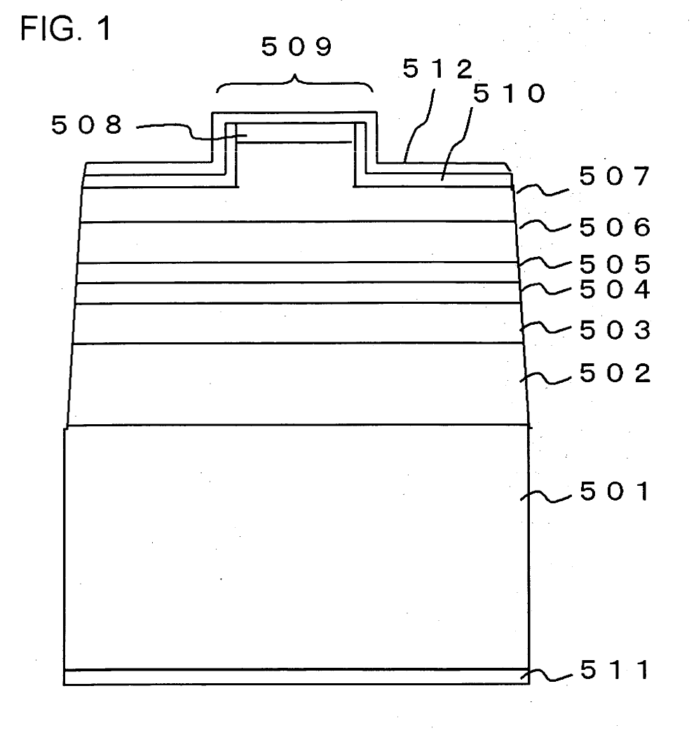

FIG. 1 is a cross sectional view of a semiconductor laser according to an embodiment of the present invention. On an independent GaN substrate 501, there are formed laminated layers consisting of a n-type clad layer 502 made of AlGaN, a n-type light confinement layer 503, a multi quantum well (MQW) layer 504 to be an active layer, a cap layer 505, a p-type light confinement layer 506, a p-type Al_{0.1}Ga_{0.9}N clad layer 507, a p-type contact layer 508, an SiO₂ insulating film 510, and a p electrode 512 on a independent GaN substrate 501. A mesa portion 509 is formed on the upper portion of the laminated layers. The side surfaces of the laminated layers along the direction of the resonator are inclined in such a direction that the resonator width is decreased from the independent GaN substrate 501 to the laminated layers. In the illustrated semiconductor laser, the side surfaces are inclined at an angle of about 60 degrees with respect to the substrate surface. The inclined side surfaces of the laminated layers become wafer cutting surfaces during chip separation. This inclined structure suppresses damages on chip separated surfaces. Particularly, in the figure, this structure can effectively suppress damages at the corner portions of the p electrode 512 at the both end portions.

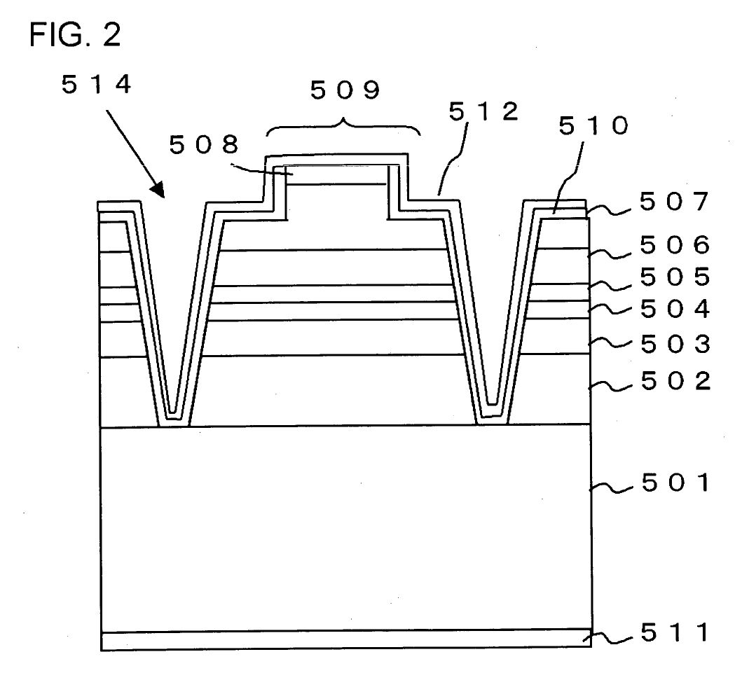

FIG. 2 is a cross sectional view of a semiconductor laser according to another embodiment of the present invention. The LD structure thereof is the same as that in FIG. 1. A pair of device separation slots 514 reaching the independent GaN substrate 501 are formed through the laminated layers. The n-type clad layer 502 made of AlGaN is exposed at the side surfaces of the device separation slots 514. The side surfaces of the device separation slots 514 are inclined in such a direction that the resonator width is decreased from the independent GaN substrate 501 to the laminated layers. The LD structure including the multi quantum well (MQW) layer 504 to be an active layer is formed in the region sandwiched between the pair of device separation slots 514. As previously described, the n-type clad layer 502 made of AlGaN on the independent GaN substrate 501 includes tensile-mode internal stresses and thus is prone to occurrences or propagation of clacks. In the illustrated semiconductor laser, since the device separation slots 514 are formed so as to split the n-type clad layer 502 made of AlGaN, it is possible to suppress damages of the LD structure during chip separation and it is also possible to prevent the propagation of clacks introduced from the side surfaces of the laminated layers along the direction of the resonator during use of the semiconductor laser, thus suppressing damages of the LD structure. Further, the device capacitance can be decreased, thus improving the laser characteristics.

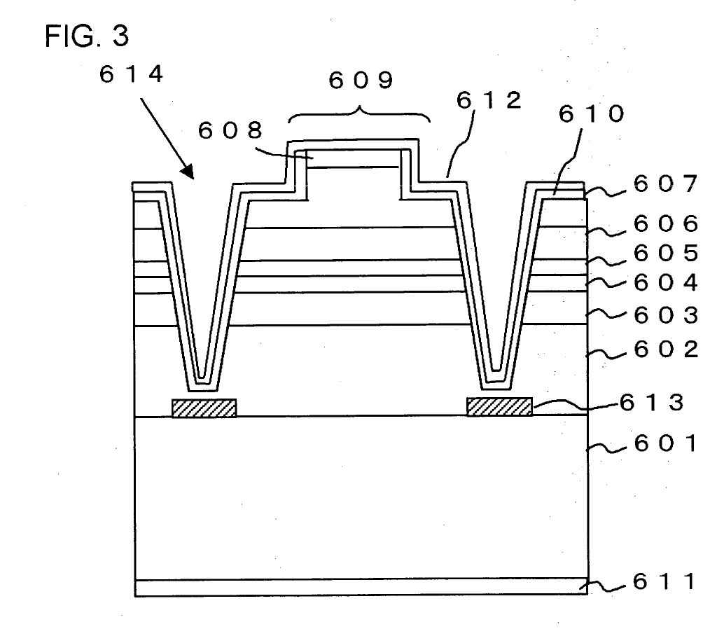

FIG. 3 illustrates a case where slots are formed by masking deposition. The device structure thereof is the same as those of the semiconductor lasers of FIG. 1 and FIG. 2. A pair of device separation slots 614 reaching the independent GaN substrate 601 are formed through the laminated layers. The n-type clad layer 602 made of AlGaN is exposed at the side surfaces of the device separation slots 614. The side surfaces of the device separation slots 614 are inclined in such a direction that the resonator width is decreased from the independent GaN substrate 601 to the laminated layers. The LD structure including the multi quantum well (MQW) layer 604 to be an active layer is formed in the region sandwiched between the pair of device separation slots 614. The side surfaces of the device separations slots 614 are grown surfaces of the semiconductor layers which have been selectively grown from masks 613 and are inclined with respect to the substrate surface at an angle of about 60 degrees. This structure can suppress the occurrence of damages within the laminated layers or the occurrence of internal distortions during the slot forming process, in addition to the effects described with respect to the semiconductor laser of FIG. 2.

### EXAMPLES

### Example 1

(Fabrication of Devices)

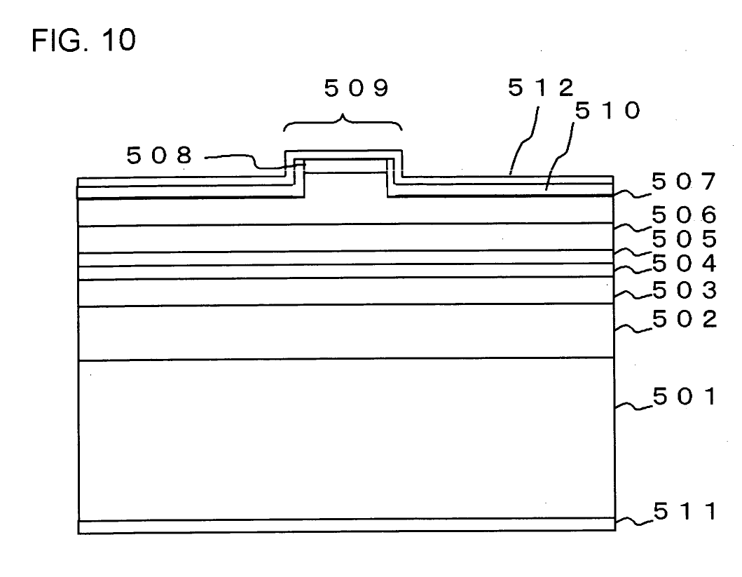

In the present example, semiconductor lasers having cross sectional structures illustrated in FIG. 1, FIG. 2 and FIG. 10 were fabricated and evaluated. Hereinafter, the semiconductor laser of FIG. 1, the semiconductor laser of FIG. 2 and the semiconductor laser of FIG. 10 will be referred to as type A, type B and type C, respectively.

Hereinafter, there will be described the procedure for fabricating these semiconductor lasers. As the substrate, an n-type GaN (0001) substrate was employed, wherein the n-type GaN (0001) substrate was grown by a FIELO method (A. Usui et. al. Jpn. J. Appl. Phys. 36 (1997) L889) to 250 μm. The substrate was an independent GaN substrate having a GaN thickness of 200 μm since exfoliation of the GaN layer had occurred due to the difference in the thermal expansion coefficient between sapphire and GaN during the substrate cooling process after the HVPE deposition. For the fabrication of the device structures, a decompression MOVPE apparatus at 300 hPa was employed. A mixed gas consisting of hydrogen and nitrogen was employed as the carrier gas. Trimethylgallium (TMG), trimethylalminum (TMG) and trimethylindium (TMI) were employed as the Ga, Al and In sources. Silane (SiH₄) and bis cyclopentadienyl magnesium (Cp₂Mg) were employed as the n-type dopant and the p-type dopant.

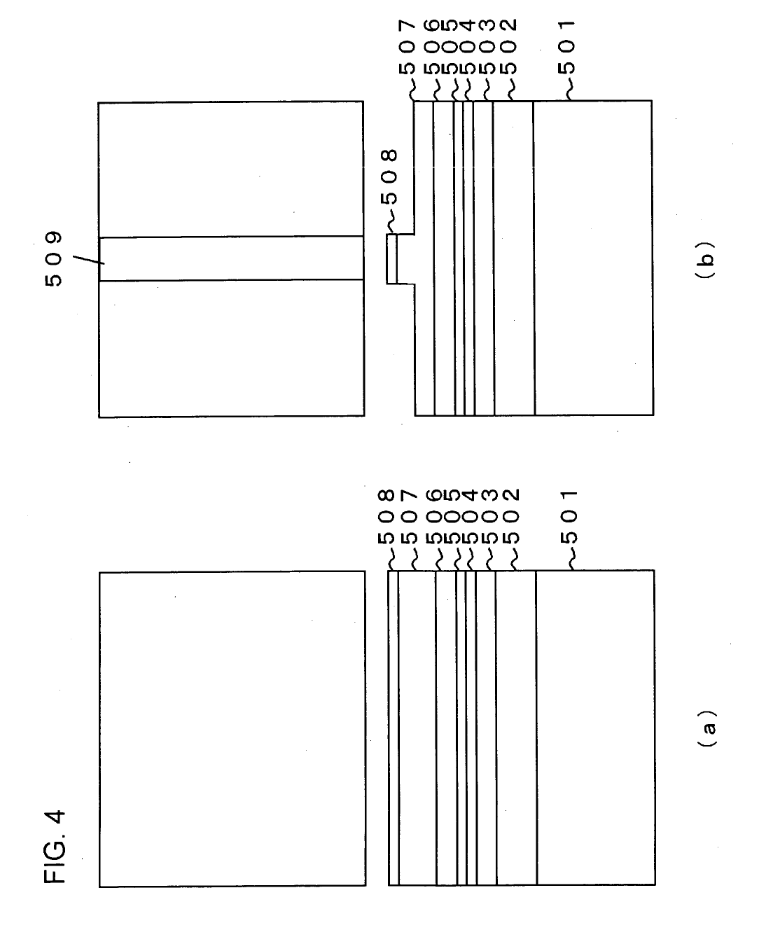

In the present embodiment, at first, a LD structure as illustrated in FIG. 4A was fabricated.

An n-type clad layer 502 made of Si-doped n-type Al_{0.1}Ga_{0.9}N (with a Si concentration of 4×10¹⁷ cm⁻³ and a thickness of 1.2 μm),

an n-type light confinement layer 503 made of Si-doped n-type GaN (with a Si concentration of 4×10¹⁸ cm⁻³ and a thickness of 0.1 μm),

a multi quantum well (MQW) layer 504 consisting of a three-period active layer consisting of In_{0.15}Ga_{0.85}N well layers (with a thickness of 3 nm) and Si-doped In_{0.01}Ga_{0.99}N barrier layers (with a Si concentration of 5×10¹⁸ cm⁻³ and a thickness of 4 nm),

a cap layer 505 made of Mg-doped p-type Al_{0.2}Ga_{0.8}N,

a p-type light confinement layer 506 made of Mg-doped p-type GaN (with an Mg concentration of 2×10¹⁹ cm−3 and a thickness of 0.1 μm),

a p-type Al_{0.1}Ga_{0.9}N clad layer 507 (with an Mg concentration of 2×10¹⁹ cm⁻³) having a thickness of 0.5 μm, and

a p-type contact layer 508 made of Mg-doped p-type GaN (with a Mg concentration 2×10²⁰ cm⁻³ and a thickness 0.1 μm)

were successively grown on the aforementioned independent GaN substrate 501 to form the LD structure of FIG. 4A.

Subsequently, mesa portions 509 including the p-type clad layer 507 and the p-type contact layer 508 were fabricated by dry etching to provide ridge type LDs having active layer stripes formed at an interval of 300 μm. While in this case a resist mask was employed to perform the dry etching, a dielectric mask such as SiO₂ may be employed.

Subsequently, three types of semiconductor layers, namely semiconductor lasers of types A, B and C, were fabricated as follows. For the semiconductor laser of type A, portions of the LD structure at the both sides of the mesa portion 509 were eliminated by dry etching at the state of FIG. 4B into a slot shape until the n-type AlGaN clad layer 502 was eliminated to form a pair of stripe-shaped device separation slots 513 reaching the independent GaN substrate 501. For the semiconductor laser of type B, portions of the LD structure at the both sides of the mesa portion 509 were eliminated by dry etching into a slot shape until the n-type AlGaN clad layer 502 was eliminated to form a pair of stripe-shaped device separation slots 514 reaching the independent GaN substrate 501. On the other hand, for the semiconductor laser of type C, no slot was formed and the subsequent process was performed.

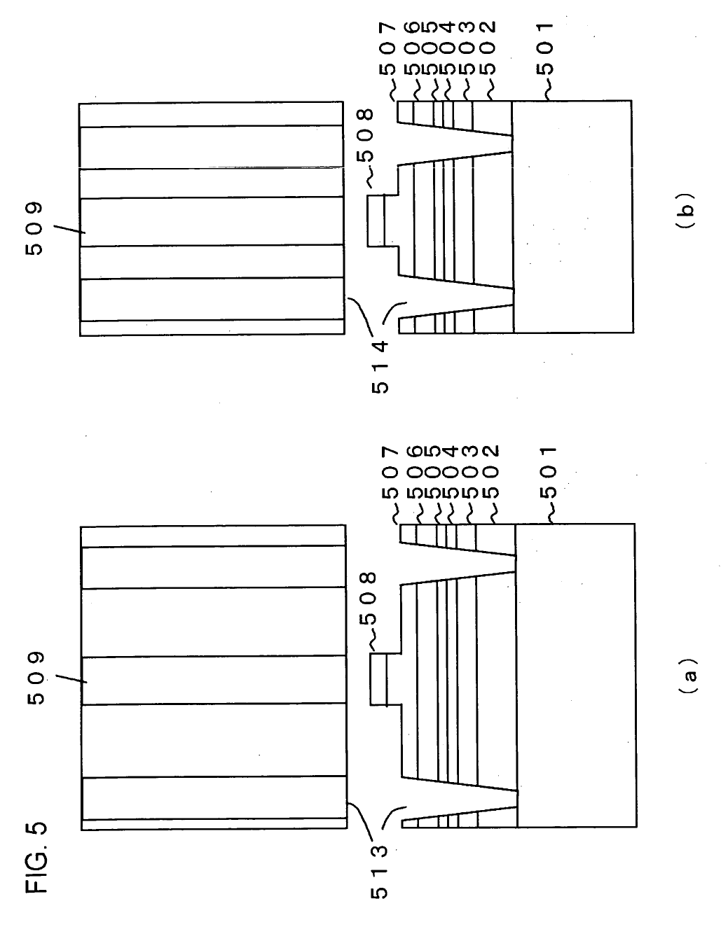

Hereinbelow, there will be described the process for forming separation slots for the type A and the type B. At the state of FIG. 4B, a resist mask having stripe shaped openings was formed (not shown). Subsequently, dry etching was applied thereto using the resist mask to form device separation slots 513 or device separation slots 514 reaching the independent GaN substrate 501. FIG. 5 is views illustrating the cross sectional structures at this state, wherein FIG. 5A and FIG. 5B illustrate the cross sectional areas of the type A and the type B, respectively. Their mesa portions both had a width of 10 μm. The distance between the pair of device separation slots of the type A and the type B were 300 μm and 50 μm, respectively. The direction in which these slots extend was <1-100>.

An ICP-plasma dry etching apparatus was employed for the dry etching and the dry etching condition was as follows for all of the types A, B and C.

RF power: 600 W

Bias RF power: 50 W

Etching gas: Cl₂ 20 sccm

Etching pressure: 1.0 Pa

Etching rate: 0.5 μm/min

Etching mask: SiO₂

For performing etching, a mask made of a silicon oxide film was employed. This mask had a film thickness of 150 nm and was thinner than usual. Further, the cross sectional area of the mask perpendicular to the direction of extension thereof had substantially a trapezoidal shape so that the side surfaces of the opening portions were inclined surfaces. Consequently, the mask opening width was gradually increased during the etching process and the resultant structure had slot portions having side surfaces which were inclined in such a direction that the width between the slot portions was decreased from the independent GaN substrate 501 to the upper portion of the LD structure. In the present example, in both of the type A, type B, the slot side surfaces were made to be inclined surfaces at an angle of about 60 degrees with respect to the substrate surface. Further, in providing the mask having substantially a trapezoidal cross sectional shape, it was important to make the mask thin and reduce the over etching in patterning of the mask using a buffered hydrofluoric acid.

Subsequently, a SiO₂ insulating film 510 was deposited and the head portions of the mesa portions were exposed by a light-exposing technique to form ridge constrictions. An n electrode 511 made of Ti/Al was formed on the back surface of the n-type substrate and a p-electrode 512 made of Ni/Au was formed on the p contact. These devices were cleaved along the direction perpendicular to the active layer stripes, namely along the (1-100) plane perpendicular to the device separation slots 513 and 514, into a bar shape having a width of 600 μm and a high reflectivity coating (with a reflectivity of 95%) made of a TiO₂/SiO₂ film was applied to one side of them. Subsequently, scribing was performed to separate the devices to fabricate semiconductor laser chips. The scribing for the devices of type A was performed at their device separation slots while the scribing for the devices of type B and type C were performed at the middle portions between adjacent active layer stripes.

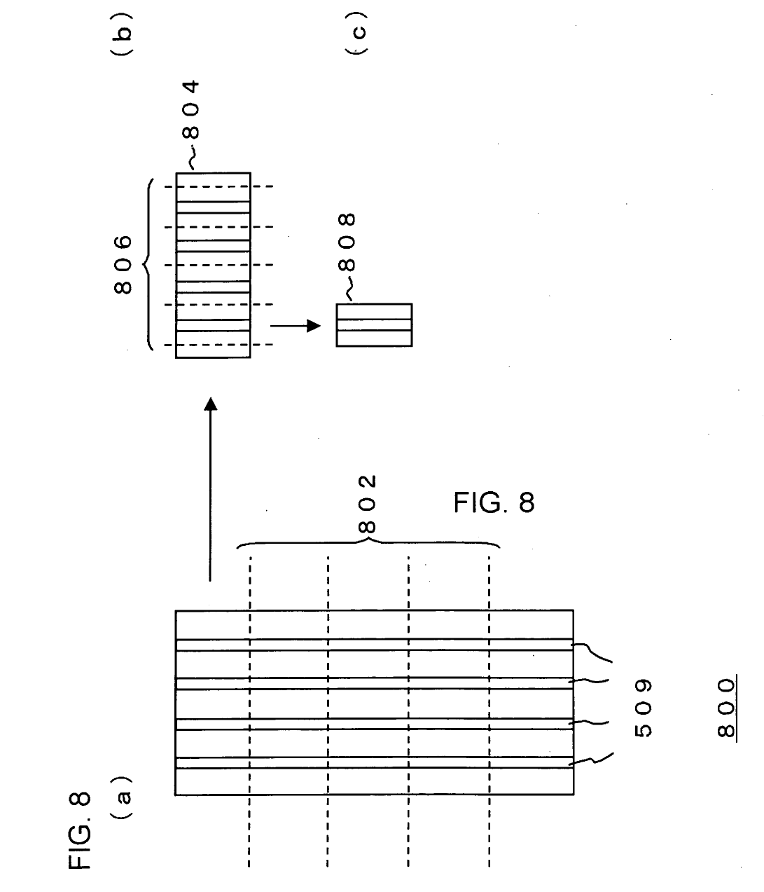

The aforementioned device separating process will be described with reference to FIG. 8. First, a wafer 800 was cleaved by cleavage planes 802 along the direction orthogonal to the direction of extension of the mesa portions 509 and the separation slots (not shown) to form laser bars (FIG. 8A) . Then, the respective bars were scribed along scribing lines 806 along the direction of extension of the mesa portions 509 and the device separation slots (not shown) to separate them into semiconductor laser chips (FIGS. 8B and C). Thus, semiconductor lasers having cross sectional structures illustrated in FIG. 1, FIG. 2 and FIG. 10 were fabricated.

(Evaluations)

The fabricated LDs of type A, B and C had oscillation threshold current densities of 2.5 kAcm⁻², 2.4 kAcm⁻²and 3.0 kAcm⁻², respectively, which were typical values and also had slope efficiencies of 1.3 W/A/facet, 1.3 W/A/facet and 0.9 W/A/facet, respectively.

After the determination of characteristics, the p electrode was removed with aqua regia and observations were performed with an optical microscope. As a result, an average of four clacks across the stripes was observed in the devices of type C. On the contrary, no clack was found in all the observed devices of type A. In the devices of type B, there were found clacks equivalent to those in the devices of type C generated from the scribed portions, but the propagation of all the clacks was suppressed by the clack preventing slots, and thus there was observed no clack across their active layers. The reason why the devices of type C had poor characteristics such as the threshold current density and the slope efficiency compared to others is that clacks increased the internal loss.

Further, the capacitances of the respective devices were determined and the types A, B and C had capacitances of 20 pF, 12 pF and 21 pF, respectively. This revealed that the device capacitance could be reduced by decreasing the effective device area with the clack propagation preventing slots.

The semiconductor laser of type A according to the present example has been separated into a chip through the device separation slots 513 reaching the independent GaN substrate 501. The device separation can be performed at the device separation slots 513 where the AlGaN clad layer has been removed, thus effectively suppressing clacks. Further, the device separation slots 513 in this semiconductor laser have inclined surfaces as previously described, thereby offering the following effects.

(i) It is possible to effectively suppress the occurrence of defects at the corner portions of the uppermost layer of the semiconductor laser which has conventionally occurred during chip separation processes or transfer of chips.

(ii) It is possible to prevent step breakages of the cover electrode during bonding of metal wiring onto the p-type cover electrode, thus realizing preferable conduction states with high stability.

The semiconductor laser of type B according to the present example includes a pair of device separation slots 514 reaching the independent GaN substrate 501. Since the active layer is formed in the region sandwiched between the device separation slots 514, it is possible to prevent clacks from propagating to the LD structure including the active layer, thus realizing a high-quality semiconductor laser. Further, in the present example, the device separation slots 514 have inclined side surfaces, thus reducing residual distortions in the semiconductor layers and also offering the effect of preventing clack propagation more prominently. Particularly, by making the slot side surfaces be inclined surfaces, it is possible to offer the effect of dispersing distortions at distortion-concentrated portions such as chip peripheral portions.

### Example 2

In the present example, there will be exemplified a case of forming device separation slots by selective deposition to fabricate devices.

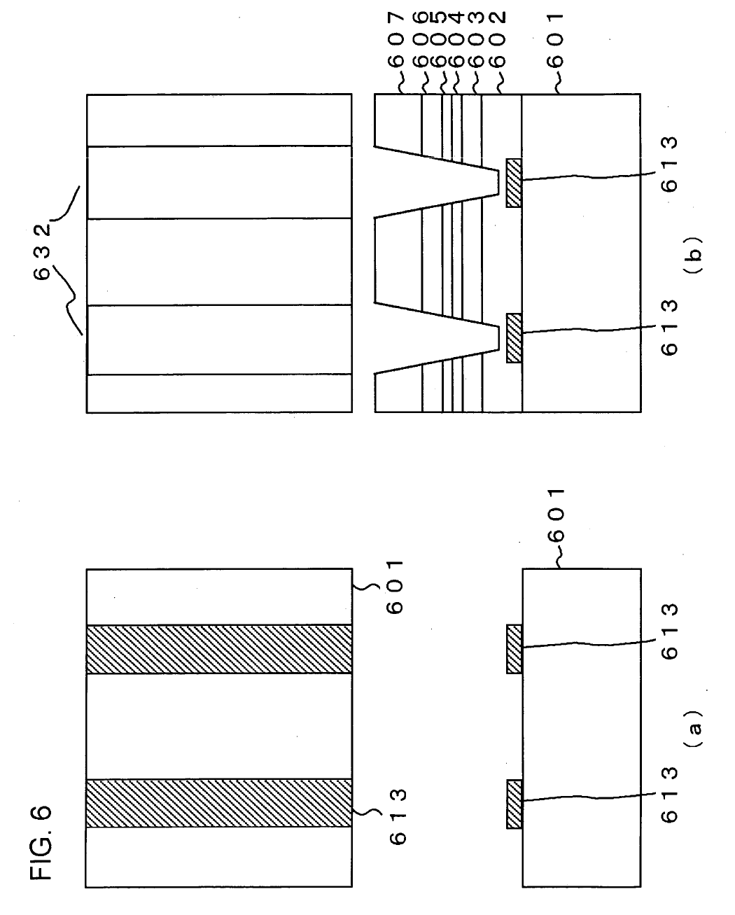

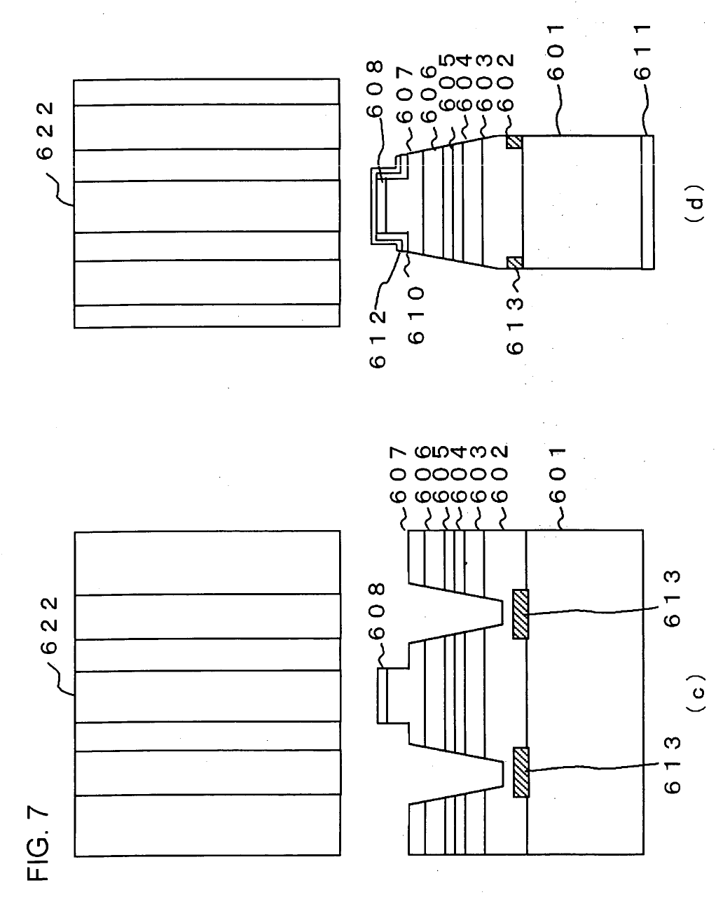

The semiconductor laser according to the present example has a structure illustrated in FIG. 3. Hereinafter, the fabricating process of the semiconductor laser will be described with reference to FIG. 6A to FIG. 7D. First, a SiO₂ insulating film with a thickness of 300 nm was deposited on an independent GaN substrate 601 similar to that employed in the first example and then stripe-shaped masks 613 made of SiO₂ with a width of 20 μm were formed by a light-exposure technique with a pitch of 300 μm (FIG. 6A). The masks 613 were formed to extend in the direction of <1-100>.

Subsequently, a n-type clad layer 602 made of Si-doped n-type Al_{0.1}Ga_{0.9}N (with a Si concentration of 4×10¹⁷ cm⁻³ and a thickness of 1.2 μm),a n-type light confinement layer 603 made of Si-doped n-type GaN (with a Si concentration of 4×10¹⁷ cm⁻³ and a thickness of 0.1 μm), a three-period multi quantum well (MQW) layer 604 to be an active layer which consists of In_{0.15}Ga_{0.85}N well layers (with a thickness of 3 nm) and Si-doped In_{0.01}Ga_{0.99}N barrier layers (with a Si concentration of 5×10¹⁸ cm⁻³ and a thickness of 4 nm), a cap layer 605 made of Mg-doped p-type Al_{0.2}Ga_{0.8}N, a p-type light confinement layer 606 made of Mg-doped p-type GaN (with an Mg concentration of 2×19 cm⁻³ and a thickness of 0.1 μm), a p-type Al_{0.1}Ga_{0.9}N clad layer (with an Mg concentration of 2×10¹⁹ cm⁻³) 607 having a thickness of 0.5 μm, and a p-type contact layer 608 made of Mg-doped p-type GaN (with an Mg concentration of 2×10²⁰ cm⁻³ and a thickness 0.1 μm) were successively grown to form laminated layers having an LD structure (FIG. 6B) . By depositing them, stripe-shaped slots extending in the direction of <1-100> were formed above the masks 613. Further, although poly-crystals were deposited on the masks 613 made of SiO₂ for selective deposition during the growth of the AlGaN layer, the thicknesses were small and thus had no influences on the process.

After the formation of the LD structure, ridge-type LDs were fabricated with the same procedure as that for the devices described in the first example. Mesa portions 609 including the p-type clad layer 607 and the p-type contact layer 608 were formed by dry etching (FIG. 7C). Then, an SiO₂ insulating film 610 was deposited and then the head portions of the mesa portions were exposed by a light-exposure technique to form ridge structures. An n electrode 611 made of Ti/Al was formed on the back surface of the n-type substrate and a p electrode 612 made of Ni/Au was formed on the p contact. These devices were cleaved along the direction perpendicular to the active layer stripes to create LD bars with a width of 600 μm and subsequently a high-reflectivity coating (with a reflectivity of 95%) made of a TiO₂/SiO₂ film was applied to one side of them. Subsequently, the SiO₂ stripe portion 601 was scribed to separate the devices. FIG. 7D is a view illustrating this state. With the aforementioned processes, the semiconductor laser illustrated in FIG. 3 was provided.

The fabricated LDs had an oscillation threshold current density of 2.5 kAcm⁻² and a slope efficiency of 1.3 W/A/facet, which were typical values. After the elimination of the p electrode through aqua regia, no clack has been found by observations with an optical microscope.

Hereinbefore, the present invention has been described on the basis of the examples. These examples have been merely exemplified and it is apparent to those skilled in the art that various modifications can be made without departing from the scope of the present invention.

For example, while a GaN substrate is employed in the examples, it is possible to employ an AlGaN substrate having an aluminum composition lower than that of the n-type clad layer. In this case, although the problem of the occurrence or the propagation of clacks will be arisen due to the lattice-constant magnitude correlation similarly to in the aforementioned examples, the present invention can effectively overcome these problems.

Further, ridge-type semiconductor lasers have been exemplified in the examples, it goes without saying that the present invention is not limited thereto and may be applied to semiconductor lasers having various structures.

Further, the p electrode can be formed on the side surfaces of the laminated layers other than the light emitting surface with an insulating film interposed therebetween.

1. A semiconductor laser comprising a GaN-based semiconductor substrate and laminated layers formed on the GaN-based semiconductor substrate which include a GaN-based semiconductor clad layer containing Al and an active layer formed thereabove,
wherein the side surfaces of the laminated layers along the direction of the resonator of the semiconductor laser are inclined in such a direction that the resonator width is decreased from the GaN-based semiconductor substrate side to the upper portion of the laminated layers.

2. The semiconductor laser according to claim 1, masks are formed on the GaN-based semiconductor substrate and the laminated layers are formed above the masks so that the side surfaces of the laminated layers along the direction of the resonator are from the grown surfaces of the semiconductor layers which have been selectively grown from the masks.

3. The semiconductor laser according to claim 1, the end surfaces of the resonator of the semiconductor laser are cleavage planes of the GaN-based semiconductor substrate and the laminated layers.

4. A semiconductor laser comprising a GaN-based semiconductor substrate and laminated layers formed on the GaN-based semiconductor substrate which include a GaN-based semiconductor clad layer containing Al and an active layer formed thereabove,
wherein there are formed a pair of slots extending in the direction of the resonator of the semiconductor laser, and
the active layer is formed in the region sandwiched between the pair of slots.

5. The semiconductor laser according to claim 4,
the laser comprising masks are provided on the bottom surfaces of the pair of slots,
wherein the side surfaces of the slots are the grown surfaces of the semiconductor layers which have been selectively grown from the masks.

6. The semiconductor laser according to claim 4, the pair of slots include exposed surfaces of the GaN-based semiconductor clad layer containing Al and the side surfaces of the slots are inclined in such a direction that the width between the slots is decreased from the GaN-based semiconductor substrate side to the upper portion of the laminated layers.

7. A semiconductor laser fabricating method comprising:
forming laminated layers including a GaN-based semiconductor clad layer containing Al and an active layer formed thereabove, on a wafer made of a GaN-based semiconductor;
forming plural slots extending in the direction of the resonator of the semiconductor laser through the laminated layers by selectively removing the laminated layers;
cutting the wafer along the direction orthogonal to the direction in which the slots extend to form bars; and
cutting the bars in parallel with the direction in which the slots extend to separate them into semiconductor laser chips;
wherein the slots include exposed surfaces of the GaN-based semiconductor clad layer containing Al and the side surfaces of the slots are inclined in such a direction that the width between the slots is decreased from the GaN-based semiconductor substrate side to the upper portion of the laminated layers.

8. The semiconductor laser fabricating method according to claim 7, wherein the bars are cut at the slots to separate them into the semiconductor laser chips.

9. The semiconductor laser fabricating method according to claim 7, wherein the bars are cut at other regions than the slots to separate them into semiconductor laser chips including a pair of slots.

10. The semiconductor laser fabricating method according to claim 7, wherein the bar forming step is performed by cleaving.

11. A semiconductor laser fabricating method comprising:
forming a plurality of stripe-shaped masks extending in a single direction on a wafer made of a GaN-based semiconductor;
selectively growing laminated layers including a GaN-based semiconductor clad layer and an active layer formed thereabove from the opening portions of the masks while forming slots just above the masks;
cutting the wafer along the direction orthogonal to the direction in which the slots extend to form bars; and
cutting the bars in parallel with the direction in which the slots extend to separate them into semiconductor laser chips.

12. A semiconductor laser fabricating method comprising:
forming laminated layers including a GaN-based semiconductor clad layer containing Al and an active layer formed thereabove, on a wafer made of a GaN-based semiconductor;
forming plural slots extending in the direction of the resonator of the semiconductor laser through the laminated layers by selectively removing the laminated layers;
cutting the wafer along the direction orthogonal to the direction in which the slots extend to form bars; and
cutting the bars in parallel with the direction in which the slots extend at regions other than the slots to separate them into semiconductor laser chips including a pair of slots.
